(19) United States
(12) Patent Application Publication
(10) Pub. No.: US 2024/0358165 A1
(43) Pub. Date: Oct. 31, 2024

(54) POCKET ROW FOR A POCKET MATTRESS SPRING CORE, A METHOD OF MANUFACTURING SUCH A POCKET ROW, AND A SEALING COMB FOR A SEALING MACHINE, FOR USE IN A METHOD OF MANUFACTURING SUCH A POCKET ROW

(71) Applicant: NESTOR SPRINGS Spolka z ograniczona odpowiedzialnoscia Spolka komandytowa, Oswiecim (PL)

(72) Inventors: Marcin Kosowski, Pogorzyce (PL); Adrian Moskala, Krakow (PL)

(73) Assignee: NESTOR SPRINGS Spolka z ograniczona odpowiedzialnoscia Spolka komandytowa, Oswiecim (PL)

(21) Appl. No.: 18/645,734

(22) Filed: Apr. 25, 2024

(30) Foreign Application Priority Data
Apr. 28, 2023 (PL) P.444661

(51) Int. Cl. A47C 27/06

(52) U.S. Cl. CPC A47C 27/064

(57) ABSTRACT

The invention relates to a pocket row for a pocket mattress spring core, formed of a sleeve of fabric comprising pockets (1), separated by a seam (3) running along the height of the pocket row, with a spring (2) in each pocket (1), characterised by the fact the seam (3) of at least some of the pockets (1) has a slit (4) transverse to the length of the pocket row, at a part of the height of the seam (3), running from the edge of the pocket (1). The invention also relates to the method for manufacturing such a pocket row and to the sealing comb (6) for the sealing machine for use in a method for manufacturing such a pocket row.

The subject of the invention is a pocket row for a pocket mattress spring core, formed of a sleeve of fabric, comprising pockets, separated by a seam running along the height of the pocket row, with a spring inserted in each pocket, a method of manufacturing such a pocket row, wherein the sleeve of fabric is sealed across its length to form pockets, and springs are inserted into the pockets, and a sealing comb for a sealing machine having an anvil and a sealing comb, for use in the method of manufacturing such a pocket row, the comb comprising an elongated body and transverse sealing teeth disposed at the edge of the body.

Various types of spring mattresses and foam mattresses are known in the art. Spring mattresses have been in use for many years. Traditional mattresses with bonnell springs (hourglass-shaped) and pocket springs, which use straight or barrel springs, are used. Pocket mattresses have the advantage that the springs, as they are not directly connected to each other (as is the case in mattresses with bonnell springs), do not interact excessively, allowing the mattress to flex essentially only at the pressure point and adjust the deflection to the body's position. An additional advantage of pocket springs is that the initial height of the spring is higher than the height of the pocket, and this relationship can be manipulated, thus controlling the hardness of the spring core. This also ensures that the pocket springs do not lose their original height because even after 40 000 cycles, the initial height of the spring does not fall below the height of the pocket. The fall is typical of bonnell springs.

A pocket mattress spring core of precisely this type is known from the application PL432050A1. It comprises a number of pocket rows formed from a sleeve of fabric, with the pockets separated by a seam running along the height of the pocket row, and each pocket contains a spring. Bonnell springs are used here, but it is known that straight or barrel springs can also be used in the mattress. The use of other springs changes the properties of the mattress slightly.

Such mattresses are normally manufactured in such a way that pocket rows are produced, formed from a sleeve of fabric, with the sleeve of fabric being sealed across its length to form pockets, and springs are inserted into the pockets. The pocket rows formed this way are joined together using adhesive, for example. A sealing machine equipped with an anvil and a sealing comb is most commonly used to produce a pocket row. The sealing comb in such a sealing machine comprises an elongated body and transverse sealing teeth located on the edge of the body. Sealing involves pressing the material on the anvil, at the point of sealing, with a comb.

It should be noted that although the advantage of this type of mattress, as mentioned, is that there is only a slight interaction between adjacent springs, this interaction still occurs, which causes the springs adjacent to the pressure point to also flex slightly. This is disadvantageous from the user's point of view.

The present invention aims to eliminate this inconvenience.

Thus, the subject of the invention is a pocket row for a pocket mattress spring core, formed of a sleeve of fabric, comprising pockets, separated by a seam running along the height of the pocket row, with a spring in each pocket, characterised by the fact that the seam of at least some of the pockets has a slit across, in relation to the length of the pocket row, a part of the height of the seam, running from the edge of the pocket.

Preferably, the slit is present on each of the seams between the pockets of the pocket row.

Preferably, the pocket row has slits running from both edges of the pocket, with the central part of the seam remaining uncut.

Preferably, the slit runs along ⅓ of the length of the seam.

When the slits run from both edges of the pocket, preferably both run along ⅓ of the length of the seam.

Preferably, the slit in the plane of the pocket row is V-shaped or U-shaped.

The subject of the invention is also a method of manufacturing a pocket row for a pocket mattress spring core, formed of a sleeve of fabric, wherein the sleeve of fabric is sealed across its length to form pockets, and springs are inserted into the pockets, characterised in that the seam of at least some of the pockets is cut at a part of its height, from the edge of the pocket, transverse to the length of the pocket row.

Preferably, each of the seams between the pockets of the pocket row is cut.

Preferably, the seam is cut at the side of both pocket edges, wherein the central part of the seam remains uncut.

Preferably, the seam is cut to ⅓ of its length.

If the seam is cut from both edges of the pocket, it is cut from both edges to ⅓ of its length.

Preferably, the seam is cut so that in the plane of the pocket row the slit is V-shaped or U-shaped.

The subject of the invention is also a sealing comb for a sealing machine, for use in a method of manufacturing a pocket row for a pocket mattress spring core, formed from a sleeve of material, wherein the sleeve of material is sealed across its length to form pockets, and wherein springs are inserted into the pockets, wherein the sealing machine has an anvil and a sealing comb, the comb comprising an elongated body and transverse sealing teeth arranged on the edge of the body, characterised by the fact that on a part of the length of the edge of the body with the teeth running from the end of the edge of the body, there is a slot in the body, dividing each of the teeth into parts and running further into the body, and in the slot there is a cutting element.

Preferably, the comb comprises two slots, each of which runs from one end of the body edge, while a section comprising no slot remains in the middle of the body edge, with a cutting element in each slot.

Preferably, the slot runs along ⅓ of the length of the body edge.

If the comb comprises two slots, each slot preferably runs along ⅓ of the length of the body edge.

Preferably, the cutting element is an elongated blade.

More preferably, the cutting element is a V-shaped or U-shaped blade.

Equally preferably, the cutting element is a resistance wire.

Preferably, the comb comprises two parts, in the working position placed one next to the other in the longitudinal axis.

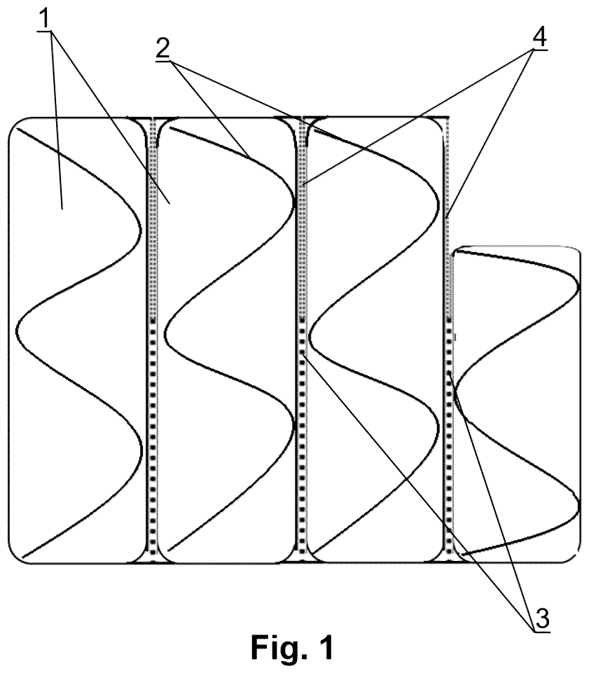

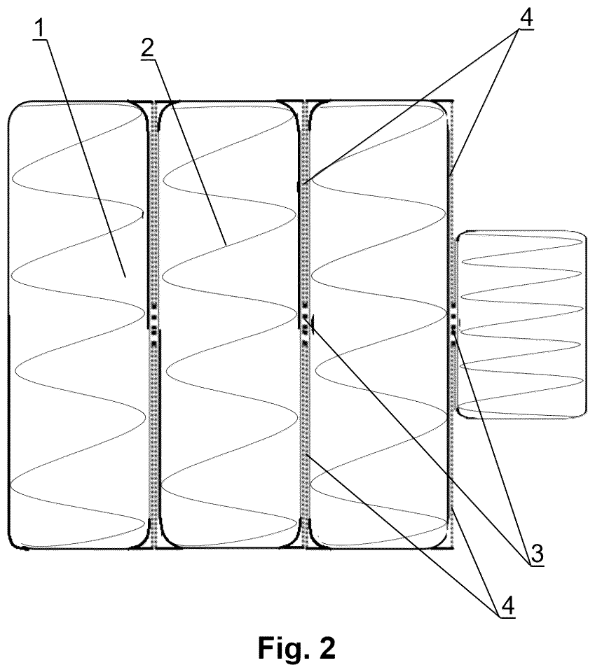

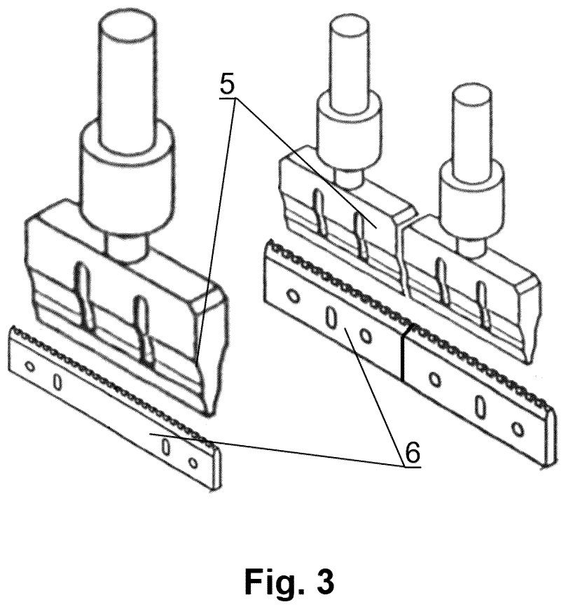

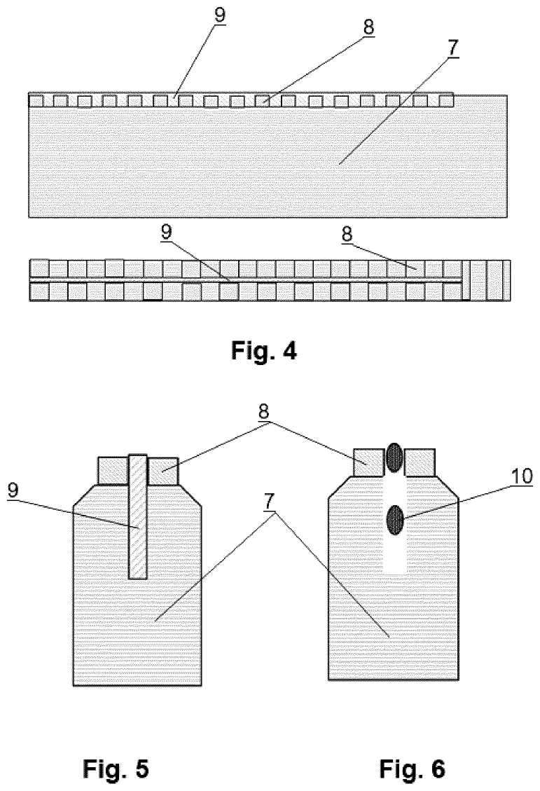

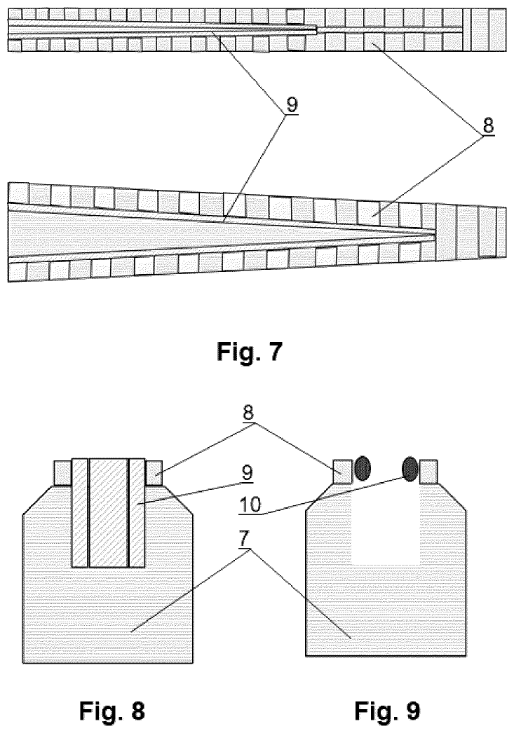

The subject of the invention is shown in embodiments on the drawings, where FIG. 1 shows a schematic representation of a pocket row according to one embodiment, FIG. 2 shows a schematic representation of a pocket row according to another embodiment, FIG. 3 shows the essential components of the state-of-the-art sealing machine in two variants, FIG. 4 shows a schematic side view and a view from the teeth side of the sealing comb embodiment, FIG. 5 and FIG. 6 show schematically the comb in cross-section, according to an embodiment with a blade and with a resistance wire respectively, FIG. 7 shows a schematic view of the teeth side according to another embodiment of the sealing comb, in two variants, FIG. 8 and FIG. 9 show schematically the comb in cross-section, according to another embodiment with a blade and with a resistance wire, respectively.

In an embodiment, a pocket row for a pocket mattress spring core is formed of a sleeve of fabric and comprises pockets 1, separated by a seam 3 running along the height of the pocket row, with a spring 2 in each pocket 1. The springs may be any springs known in the art for such application. The seam 3 of at least some of the pockets 1 has a slit 4 across a part of the height of seam 3, in relation to the length of the pocket row, running from the edge of pocket 1. According to a preferred embodiment shown in FIG. 1, slit 4 is present on each of the seams 3 between the pockets 1 of pocket row. FIG. 2 shows another embodiment in which the slits 4 run from both edges of the pocket 1, with the central part of the seam 3 remaining uncut.

In mattresses according to the art, at point pressure, the associated spring 2 flexes, pulling the pocket 1 material in which it is placed. As pockets 1 are connected over their entire height, the material of the adjacent pockets 1 also stretches, causing the adjacent springs 2 to also deflect slightly. The slits 4 present in the pocket row according to the present invention cause that, when point pressure is applied to the spring 2, the stretching material of its pocket 1 does not pull the material of the adjacent pocket 1 thus eliminating unintentional deflection of the adjacent spring 2 as well.

According to a preferred embodiment, the slit 4 runs along ⅓ of the length of the seam 3, and if the slits 4 run from both edges of the pocket 1, they both run along ⅓ of the length of the seam 3, while the middle part of the seam 3 remains uncut.

According to another preferred embodiment, a slit 4 having, in the plane of the pocket row, a V or U shape is used to improve the deflection of the single pocket 1.

According to the embodiment of the method (not shown in the figures), the pocket row for a pocket mattress spring core, formed from a sleeve of fabric, is produced in such a way that the sleeve of fabric is sealed across its length to form pockets 1, and springs 2 are inserted into the pockets 1, and the seam 3 of at least some of the pockets 1 is cut at a part of its height, from the edge of the pockets 1, transverse to the length of the pocket row.

According to one embodiment, each of the seams 3 between the pockets 1 of the pocket row is cut.

According to some embodiment, seam 3 is cut on the side of both edges of pocket 1, with the central part of seam 3 remaining uncut.

According to a preferred embodiment, seam 3 is cut to ⅓ of its length.

If seam 3 is cut from both edges of pocket 1, then on both sides the seam 3 is cut to ⅓ of its length, while the middle part of seam 3 remains uncut.

According to one embodiment, the seam 3 is cut so that in the plane of the pocket row, the slit 4 has a V or U shape.

For the production of pocket rows, sealing machines are often used, examples of which according to the art are shown in FIG. 3. As can be seen, such a sealing machine has an anvil 5 and a sealing comb 6. The sleeve of material is moved longitudinally through the sealing machine (manually or automatically) and from time to time a transverse seam 3 is made on the sleeve by pressing the material to the anvil 5 with the comb 6. This creates pockets 1, into which springs 2 are inserted successively, or after all pockets 1 have been created. The traditional comb 6 comprises an elongated body 7 and transverse sealing teeth 8 located on the edge of the body. The sealing machine can comprise one long comb 6 and one long anvil 5 (variant on the left of FIG. 3) or it can comprise two or more anvils 5 and combs 6 placed one next to the other in the longitudinal axis (variant with two anvils 5 and combs 6 shown on the right side of FIG. 3).

FIG. 4 shows, in one embodiment, a single comb 6 according to the invention, in side view and as seen from the side of the teeth 8. At a part of the length of the edge of the body 7 with the teeth 8 running from the end of the edge of the body 7, there is a slot in the body 7, dividing each of the teeth 8 into parts and running further into the body 7, and a cutting element 9, 10 is placed in the slot. The cutting element can be an elongated blade 9, shown in FIG. 5 showing the comb 6 in cross-section, or the resistance wire 10, shown in FIG. 6 (also comb 6 in cross-section).

In an embodiment not shown, the comb 6 comprises two slots, each of which runs from one end of the edge of the body 7 while in the middle of the edge of the body 7 a portion comprising no slot remains, with a cutting element 9, 10 inserted in each of the slots. This embodiment allows producing the slits 4 from both edges of the pocket row.

In one embodiment, the slot runs along ⅓ of the length of the edge of body 7. In the embodiment with two slots, each slot runs along ⅓ of the length of the body 7, with the section comprising no slot remaining in the middle.

According to a preferred embodiment shown in FIGS. 7 and 8 the cutting element is a V-shaped blade 9. As can be seen, it can be more or less bifurcated-obviously then a slot of a width increasing towards the edge is used, which is obvious to a person skilled in the art.

According to some embodiment (not shown), the blade may be U-shaped. FIG. 9 shows an embodiment with resistance wire 10 in an alternative arrangement so that a V-or U-shaped slit 4 is also achieved.

In an embodiment not shown, the comb 6 comprises two parts, in the working position placed one next to the other in the longitudinal axis.

Such two parts form a single unit, which may-respectively-have one slot and a cutting element 9, 10 or two slots and cutting elements 9, 10.

To improve operation, the sealing machine's anvil can be fitted with an insert, such as Teflon or another material to improve cutting efficiency.

Obviously, the invention is not limited to the embodiments described above, and the features indicated in the claims can be used in any combination appropriate to the particular application of the invention.

1. A pocket row for a pocket mattress spring core, formed by a sleeve of fabric, comprising pockets (1), separated by a seam (3) running along the height of the pocket row, each pocket (1) containing a spring (2), characterised in that the seam (3) of at least some of the pockets (1) has a slit (4) transverse to the length of the pocket row, at a part of the height of the seam (3), running from the edge of the pocket (1).

2. Pocket row according to claim 1, characterised in that the slit (4) is present on each of the seams (3) between the pockets (1) of the pocket row.

3. Pocket row according to claim 1, characterised in that it has slits (4) running from both edges of the pocket (1), with the central part of the seam (3) remaining uncut.

4. Pocket row according to claim 1, characterised in that the slit (4) runs along ⅓ of the length of the seam (3).

5. Pocket row according to claim 1, characterised in that the slit (4) in the plane of the pocket row is V-shaped or U-shaped.

6. A method of manufacturing a pocket row for a pocket mattress spring core, formed from a sleeve of fabric, wherein the sleeve of fabric is sealed across its length to form pockets (1), and springs (2) are inserted into the pockets (1), characterised in that the seam (3) of at least some of the pockets (1) is cut at a part of its height, from the edge of the pocket (1), transversely to the length of the pocket row.

7. Method according to claim 6, characterised in that each of the seams (3) between the pockets (1) of the pocket row is cut.

8. Method according to claim 6, characterised in that the seam (3) is cut at the side of both edges of the pocket (1), while the central part of the seam (3) remains uncut.

9. Method according to claim 6, characterised in that the seam (3) is cut to ⅓ of its length.

10. Method according to claim 6, characterised in that the seam (3) is cut so that in the plane of the pocket row the slit (4) is V-shaped or U-shaped.

11. A sealing comb for the sealing machine, for use in a method of manufacturing a pocket row for a pocket mattress spring core, formed of a sleeve of fabric, wherein the sleeve of fabric is sealed across its length to form pockets (1), and wherein springs (2) are inserted into the pockets (1), wherein the sealing machine has an anvil (5) and a sealing comb (6), the comb (6) comprising an elongated body (7) and transverse sealing teeth (8) located on the edge of the body, characterised in that on a part of the length of the edge of the body (7) with the teeth (8), running from the end of the edge of the body (7), there is a slot in the body (7), dividing each of the teeth (8) into parts and running further into the body (7), and in the slot there is a cutting element (9, 10).

12. Sealing comb according to claim 11, characterised in that it comprises two slots, each of which runs from one end of the edge of the body (7) while in the middle of the edge of the body (7) there remains a part that does not comprise a slot, the cutting element (9, 10) being placed in each of the slots.

13. Sealing comb according to claim 11, characterised in that the slots run to ⅓ of the length of the body edge (7).

14. Sealing comb according to claim 11, characterised in that the fact that the cutting element is an elongated blade (9), preferably a V-shaped blade (9) or U-shaped blade (9), or a resistance wire (10).

15. Sealing comb according to claim 11, characterised in that it comprises two parts that in the working position are placed one next to the other in the longitudinal axis.
